(19) United States
(12) Patent Application Publication
(10) Pub. No.: US 2019/0034036 A1
(43) Pub. Date: Jan. 31, 2019

(54) DISPLAY DEVICE, ELECTRONIC DEVICE, AND WEARABLE DEVICE

(71) Applicant: SEIKO EPSON CORPORATION, Tokyo (JP)

(72) Inventor: Noriaki HIRAIDE, SHIOJIRI-SHI (JP)

(73) Assignee: SEIKO EPSON CORPORATION, Tokyo (JP)

(21) Appl. No.: 16/034,753

(22) Filed: Jul. 13, 2018

(30) Foreign Application Priority Data
Jul. 28, 2017 (JP) 2017-146685

(51) Int. Cl. G06F 3/043; G06F 1/16; F21V 8/00

(52) U.S. Cl. CPC G06F 3/0436; G02B 6/0038; G06F 1/163

(57) ABSTRACT

A display device includes a display panel, a light emitting section, and a cover provided on a display surface side of the display panel and configured to guide light emitted from the light emitting section and irradiate the display surface.

### CROSS-REFERENCES TO RELATED APPLICATIONS

This application claims priority to Japanese Patent Application No. 2017-146685, filed Jul. 28, 2017, the entirety of which is herein incorporated by reference.

### BACKGROUND

### 1. Technical Field

The present invention relates to a display device, an electronic device, a wearable device, and the like.

### 2. Related Art

As a display panel (a display body) of an electronic device, there has been widely known a display panel visually recognized by emitting transmitted light from the back of the display panel. A display panel including an irradiating section that irradiates light from the back of the display panel (hereinafter referred to as backlight) is, for example, a liquid crystal panel (a transmission-type liquid crystal panel). The display panel including the backlight has low visibility in outdoor and other places and has large power consumption.

There has also been known a reflection-type display panel visually recognized by irradiating light from the front of the display panel. As a display panel including an irradiating section that irradiates light from the front of the display panel (hereinafter referred to as frontlight), there are, for example, a reflection-type liquid crystal panel and an electrophoresis display device. The reflection-type display panel is capable of securing visibility even in an environment in which visibility of the display panel including the backlight is low. The reflection-type display panel also has an advantage that power consumption is small.

For example, JP-A-2016-95563 (Patent Literature 1) discloses a display device configured by laying a transparent cover glass, a frontlight, and an electronic paper one on top of another in order. JP-A-2004-78613 (Patent Literature 2) discloses a display device in which a reflection-type liquid crystal display and a frontlight, on which light emitted from a light source is made incident, are disposed to overlap.

A light guide plate type is used as the frontlight and the backlight. The light guide plate type has an advantage that light emission unevenness is small.

Usually, the frontlight is combined with the display panel.

However, in the structures in the past disclosed in Patent Literature 1 and Patent Literature 2, three optical components (elements), that is, the cover glass, the frontlight, and the electronic paper (the display panel), are disposed to overlap in the display device. Therefore, it is difficult to reduce the thickness (the height) of the display device.

### SUMMARY

An advantage of some aspects of the invention is to solve at least a part of the problems described above, and the invention can be implemented as the following forms or application examples.

An aspect of the invention relates to a display device including: a display panel; a light emitting section; and a cover provided on a side of a display surface of the display panel and configured to guide light emitted from the light emitting section and irradiate the display surface.

With such a configuration, in the display device including the display panel visually recognized by the irradiation of the light from the side of the display surface, the cover has a function of a light guide body (a light guide or a frontlight). Therefore, because the light emitted from the light emitting section is guided by the cover and irradiated on the display surface, it is possible to reduce the thickness (the height) of the display device.

In the aspect of the invention, the display device may include a ring-like light guide body provided to surround the cover in a planar view from a direction crossing the display surface.

With such a configuration, because light emission unevenness of the cover can be reduced, it is possible to increase visibility of the display panel.

In the aspect of the invention, the display device may include a housing to which the display panel and the cover are attached, and the housing and the ring-like light guide body may be integrally formed.

With such a configuration, it is possible to increase waterproof performance of the display device.

In the aspect of the invention, the display device may include a reflection surface configured to, when a direction from the light emitting section toward the cover is represented as a first direction, reflect the emitted light in a second direction crossing the first direction.

With such a configuration, it is possible to improve flexibility of disposition of the light emitting section.

In the aspect of the invention, the display device may include a light guide body configured to guide the emitted light in the first direction.

With such a configuration, it is possible to improve the flexibility of the disposition of the light emitting section.

In the aspect of the invention, the display device may include a housing to which the display panel and the cover are attached, and the housing and the light guide body may be integrally formed.

With such a configuration, it is possible to increase the waterproof performance of the display device.

In the aspect of the invention, the reflection surface may be formed on the light guide body.

With such a configuration, because the reflection surface is provided on the light guide body, it is possible to appropriately guide the light emitted from the light emitting section to the cover.

In the aspect of the invention, the reflection surface may be formed at an end portion of the cover.

With such a configuration, it is possible to appropriately guide the light emitted from the light emitting section in the cover according to an end portion shape of the cover.

In the aspect of the invention, the display device may include a bezel provided to surround the cover in a planar view from a direction crossing the display surface, and the reflection surface may be formed on the bezel.

With such a configuration, it is possible to appropriately guide the light emitted from the light emitting section to the cover using the bezel.

In the aspect of the invention, grooves of a predetermined pattern may be formed on a surface of the cover on a side of the display panel.

With such a configuration, because the guided light can be scattered by the cover, it is possible to perform irradiation without unevenness on the display surface of the display panel.

In the aspect of the invention, the display panel may be either a reflection-type liquid crystal panel or an electrophoresis display device.

With such a configuration, it is possible to configure the display device using display panels of various types.

Another aspect of the invention relates to an electronic device including the display device described above.

Still another aspect of the invention relates to a wearable device including the display device described above.

### BRIEF DESCRIPTION OF THE DRAWINGS

The invention will be described with reference to the accompanying drawings, wherein like numbers reference like elements.

FIG. 1 is a perspective view of a wearable device including a display device according to a first embodiment.

FIG. 2 is a sectional view of the display device according to the first embodiment.

FIG. 3 is a plan view of the display device according to the first embodiment.

FIG. 4 is a sectional view of a display device according to a second embodiment.

FIG. 5 is a plan view of the display device according to the second embodiment.

FIG. 6 is another sectional view of the display device according to the second embodiment.

FIG. 7 is another plan view of the display device according to the second embodiment.

FIG. 8 is another sectional view of the display device according to the second embodiment.

FIG. 9 is another plan view of the display device according to the second embodiment.

FIG. 10 is a sectional view of a display device according to a third embodiment.

FIG. 11 is a plan view of the display device according to the third embodiment.

FIG. 12 is a sectional view of a display device according to a modification in which a light scattering sheet is provided.

FIG. 13 is a sectional view of a display device according to a modification in which a solar panel is provided.

### DESCRIPTION OF EXEMPLARY EMBODIMENTS

Embodiments are explained below. Note that the embodiments explained below do not unduly limit the content of the invention described in the appended claims. Not all of components explained in the embodiments are essential constituent elements of the invention.

### 1. First Embodiment

In recent years, there has been widely known a reflection-type display panel visually recognized through a frontlight. The reflection-type display panel has advantages that power consumption is small and visibility under an environment with strong external light in outdoor and other places is high compared with a display panel (a transmission-type liquid crystal panel, etc.) visually recognized through a backlight.

In recent years, display devices are more often mounted on devices assumed to be carried and worn by users such as a portable terminal device and a wearable device. In such devices, a reduction in the size (the thickness) of the devices is very important. The wearable devices and the like have a small battery capacity compared with a stationary device. Therefore, there is an increasing demand for a reflection-type display panel having small power consumption. That is, a reduction in the thickness of a display device including the reflection-type display panel is considered to be extremely important.

However, in the method in the past disclosed in Patent Literature 1 and the like, the display device is configured by laying the three optical components, that is, the cover glass, the frontlight, and the electronic paper, one on top of another. Therefore, it is not easy to reduce the thickness of the display device.

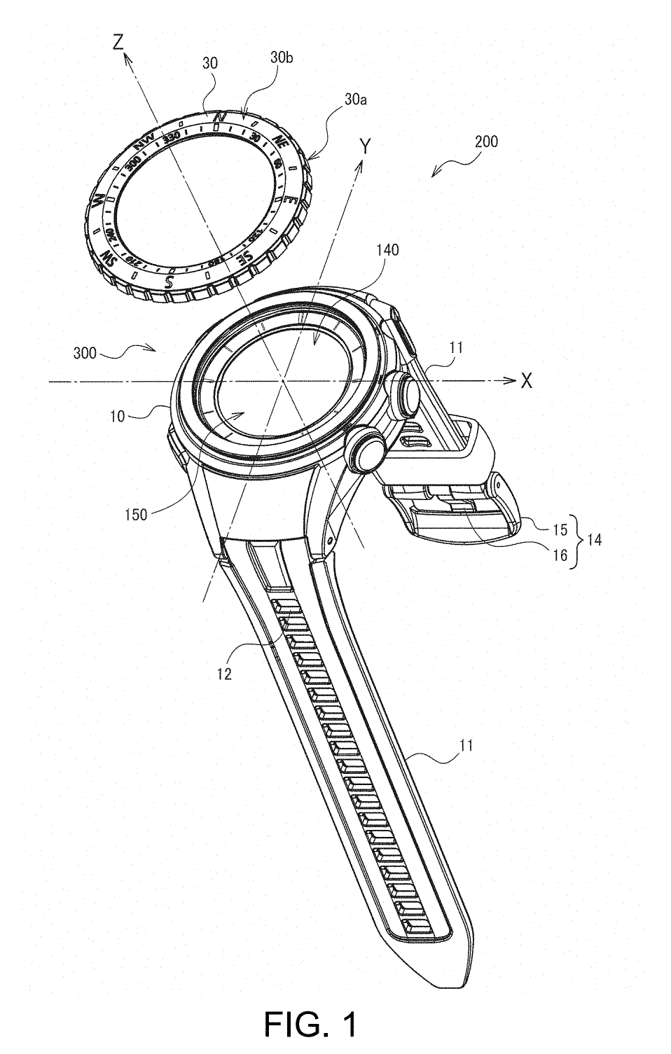

As measures against the problems, a display device 300 according to this embodiment includes, as shown in FIGS. 1 to 3, a display panel 150, a light emitting section 110, and a cover 140 provided on the side of a display surface of the display panel 150 and configured to guide light emitted from the light emitting section 110 and irradiate the display surface. One or a plurality of light emitting sections 110 may be provided in the display device 300. With such a configuration, the cover 140 can be used as a frontlight (also referred to as light guide, light guide body, and light guide plate). Therefore, it is possible to reduce the thickness of the display device 300 compared with the structure in the past in which the cover 140 and the frontlight are separately configured. The display surface represents a surface having a large area in the display panel 150, which is a tabular member, and used for display of information (a surface used for visual recognition of information by a user). As the shape of the display surface, various modified implementations are possible. The shape of the display surface may be a circular shape (not limited to a perfect circle) or may be a polygonal shape.

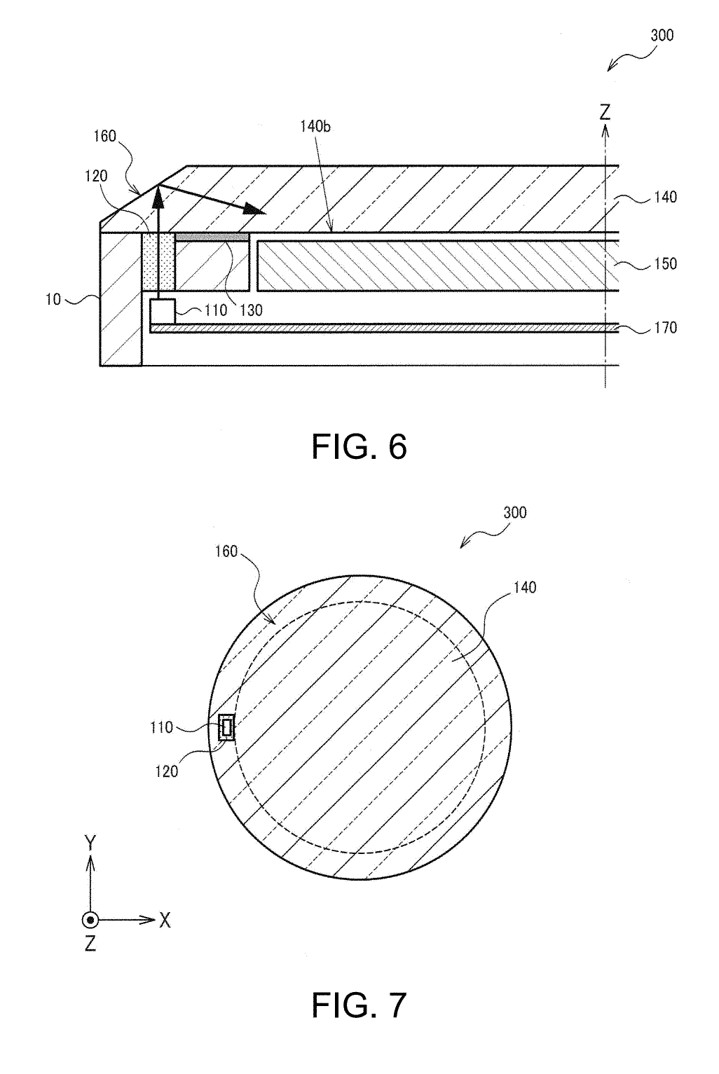

FIG. 1 is a perspective view (an exploded view) of a wearable device 200 including the display device 300 according to this embodiment. As explained above, the display device 300 includes the display panel 150, the light emitting section 110, and the cover 140. The display device 300 may have, for example, a configuration excluding a band section 11 in the wearable device 200. Alternatively, the display device 300 may have a configuration not including a housing 10 (e.g., a module for display attachable to housings having various shapes). Various modified implementations of a specific configuration of the display device 300 are possible. Note that the wearable device 200 is not limited to the configuration shown in FIG. 1. Various modified implementations for omitting a part of the components and adding other components are possible. In FIG. 1, an example is shown in which a bezel 30 (a rotary bezel) usable as an azimuth meter is attached to the housing 10. Unevenness is provided on a side surface section 30a of the bezel 30. A scale, characters, and numbers are provided on an upper surface section 30b of the bezel 30. However, various modified implementations of the shape of the bezel 30 are possible. As explained below with reference to FIG. 6, the bezel 30 may be removed from the display device 300. Alternatively, a fixed bezel, which is not a rotating body, may be used as the bezel 30.

As shown in FIG. 1, the wearable device 200 includes the housing (a case section) 10 and the band section 11 for fixing the housing 10 to the body (in a narrow sense, a wrist) of the user. Fitting holes 12 and a buckle 14 are provided in the band section 11. The buckle 14 is configured from a buckle frame 15 and a locking section (a protruding bar) 16. In the wearable device 200, a plurality of fitting holes 12 are provided in the band section 11. The wearable device 200 is worn on the user by inserting the locking section 16 of the buckle 14 into any one of the plurality of fitting holes 12. The plurality of fitting holes 12 are provided along the longitudinal direction of the band section 11 as shown in FIG. 1.

In the housing 10 of the wearable device 200, the cover (a windshield member, a windshield glass, a cover glass, or a light transmitting member) 140 and the display panel (a display section or a display body) 150 are provided. In the housing 10, a touch panel (not shown in FIG. 1) and a substrate 170 including a processing circuit may be provided. In the housing 10, an opening section is provided that is brought to the opposite side of a subject (the wrist of the user) side when the wearable device 200 is worn. The cover 140 is fit in the outer edge portion of the opening section to close (seal) the opening section. That is, in a state in which the cover 140 is attached to the housing 10, the cover 140 is provided in a position exposed to the outside. A housing section formed as a closed space by the cover 140 and the housing 10 is provided. The display panel 150 is disposed in the housing section. That is, the cover 140 is a member for preventing liquid and the like from flowing into the housing 10 from the outside or preventing a shock on the display panel 150 and the like provided inside the housing 10. In a narrow sense, the cover 140 is a windshield plate (a translucent cover) in a wristwatch.

Considering that the cover 140 is used as the frontlight, the cover 140 is configured by a transparent member capable of guiding light. For example, the cover 140 is made of glass, acrylic resin (acryl or glass), polycarbonate, or the like.

The display surface of the display panel 150 is disposed in a position where the display surface is visually recognizable through the cover 140. The display panel 150 is provided between the cover 140 and the substrate 170. In other words, in a state in which the wearable device 200 is worn on a predetermined part (a wrist, etc.) of the user, the display panel 150 is provided in a position further on the predetermined part side than the cover 140.

The display panel 150 is a reflection-type display panel visually recognized with light irradiated from the cover 140. Specifically, light emitted from the light emitting section 110 and guided by the cover 140 is irradiated on the display surface, whereby the display surface can be visually recognized. The display panel 150 is, for example, either a reflection-type liquid crystal panel or an electrophoresis display device. The electrophoresis display device may be an electrophoresis device of a partition wall type including an electrophoresis layer disposed between two substrates, which are disposed to be opposed to each other, and including a dispersion medium partitioned into a plurality of cells by partition walls or may be an electrophoresis device of a microcapsule type in which a plurality of capsules including dispersion media and electrophoresis particles are disposed between two substrates disposed to be opposed to each other. Alternatively, electrophoresis devices of other forms may be used as the display panel 150.

In FIG. 1 and FIGS. 2 and 3 referred to below, a coordinate system is set on the basis of the housing 10 of the wearable device 200. A direction crossing the display surface of the display panel 150, that is, when the display surface side of the display panel 150 is represented as a front surface (an upper surface), a direction from a rear surface (a lower surface) toward the front surface is represented as a Z-axis positive direction. Alternatively, a direction away from the housing 10 in the normal direction of the display surface of the display panel 150 may be defined as the Z-axis positive direction. In a state in which the wearable device 200 is worn on a subject, the Z-axis positive direction is equivalent to a direction from the subject toward the housing 10. Two axes orthogonal to the Z axis are represented as X and Y axes. In particular, a direction in which the band section 11 is attached to the housing 10 is set as the Y axis.

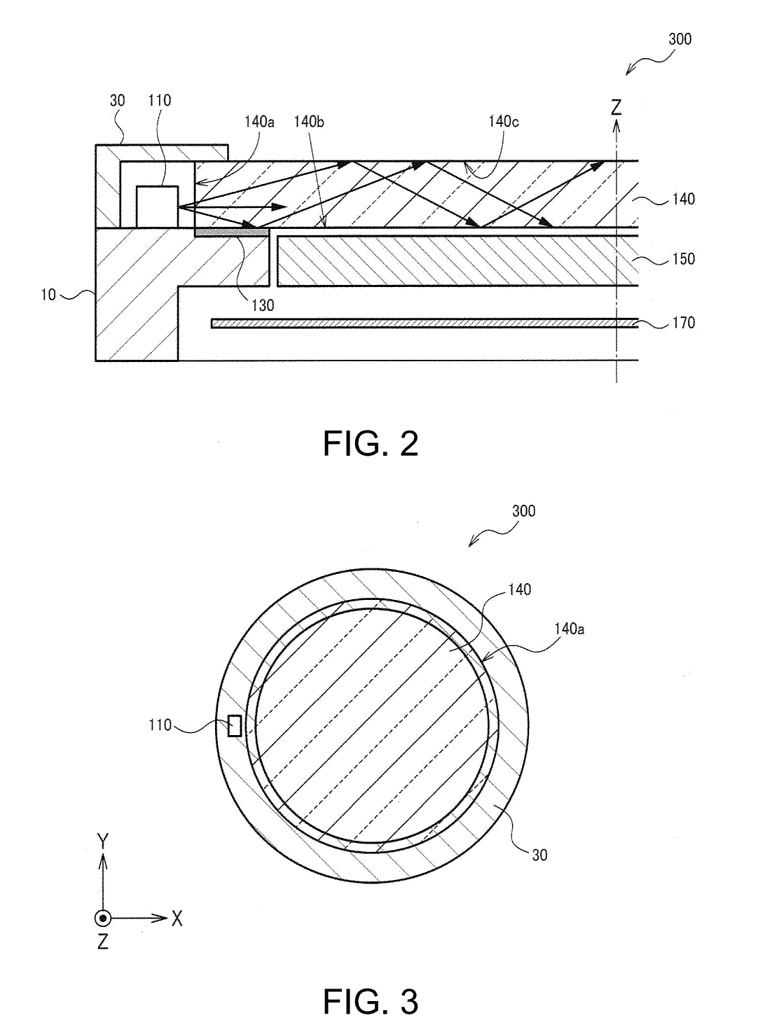

FIG. 2 is a sectional view in an XZ plane shown in FIG. 1. FIG. 3 is a plan view of the wearable device 200 (in particular, a portion excluding the band section 11) observed from a viewpoint provided further on the Z-axis positive direction side than the wearable device 200 toward a Z-axis negative direction. In the following explanation, in this specification, an observation state shown in FIG. 3, that is, a state of observation from a direction crossing (in a narrow sense, orthogonal to) the display panel surface is represented as a “planar view”. Note that, in FIGS. 2 and 3, the shapes of the rotary bezel and the like are simplified and shown. In FIG. 3, members blocked by other members and directly visually unrecognizable are also shown as appropriate for convenience of explanation. The blocked members are shown as appropriate in other plan views such as FIG. 5 as well.

As shown in FIG. 2, the cover 140 and the display panel 150 are provided to be stacked in a Z-axis direction. The cover 140 is bonded to the housing 10 using an adhesive layer 130 in a part of a lower surface 140b (a surface on the Z-axis negative direction side or a surface on the display panel 150 side). However, fixing of the cover 140 to the housing 10 is not limited to the bonding. As shown in FIGS. 2 and 3, the bezel 30 is set to overlap the circumferential edge portion of the cover 140 in the planar view.

The light emitting section 110 in this embodiment is provided in any position along the outer edge of the cover 140 in the planar view. The light emitting section 110 irradiates light on the cover 140 from a direction crossing the Z axis. The direction crossing the Z axis is a direction along the surface of the cover 140 and the display surface of the display panel 150. The light emitting section 110 may be an LED (Light Emitting Diode) widely in use, may be an OLED (Organic Light Emitting Diode), or may be other light emitting elements. In general, light emitted from the light emitting section 110 is diverging light.

In an example shown in FIGS. 2 and 3, the light emitting section 110 is provided in a position overlapping the bezel 30 in the plan view and a position not overlapping the cover 140. Note that, in FIG. 3, an example is shown in which one light emitting section 110 is provided. However, the display device 300 may include a plurality of light emitting sections 110. For example, considering that light emission unevenness of the display panel 150 is reduced such that a wide range can be illuminated uniformly without unevenness, N (N is an integer equal to or larger than 2) light emitting sections 110 are desirably respectively provided at N dividing points on the circumference surrounding the outer edge of the cover 140. Similarly, the plurality of light emitting sections 110 may be provided in other embodiments explained below.

Processing by blast may be performed on a side surface 140a of the cover 140 to roughen the side surface 140a to form the side surface 140a as an embossed surface or form an uneven shape or a groove shape on the side surface 140a. The blast (shot blast) means processing for projecting grains to the cover 140, which is a workpiece, to cause the grains to collide with the cover 140. In this way, it is possible to reduce leaks of light guided by the cover 140 to the outside from the side surface 140a and efficiently utilize reflected light to the inside of the cover 140. That is, it is possible to efficiently guide light on the cover 140. Therefore, it is possible to increase light reflected on the display surface of the display panel 150 and increase visibility of the display panel 150. A member having high light diffusion may be used as the cover 140 rather than processing the side surface 140a of the cover 140. Alternatively, the member having high light diffusion may be used as the cover 140 and then the side surface 140a of the cover 140 may be machined.

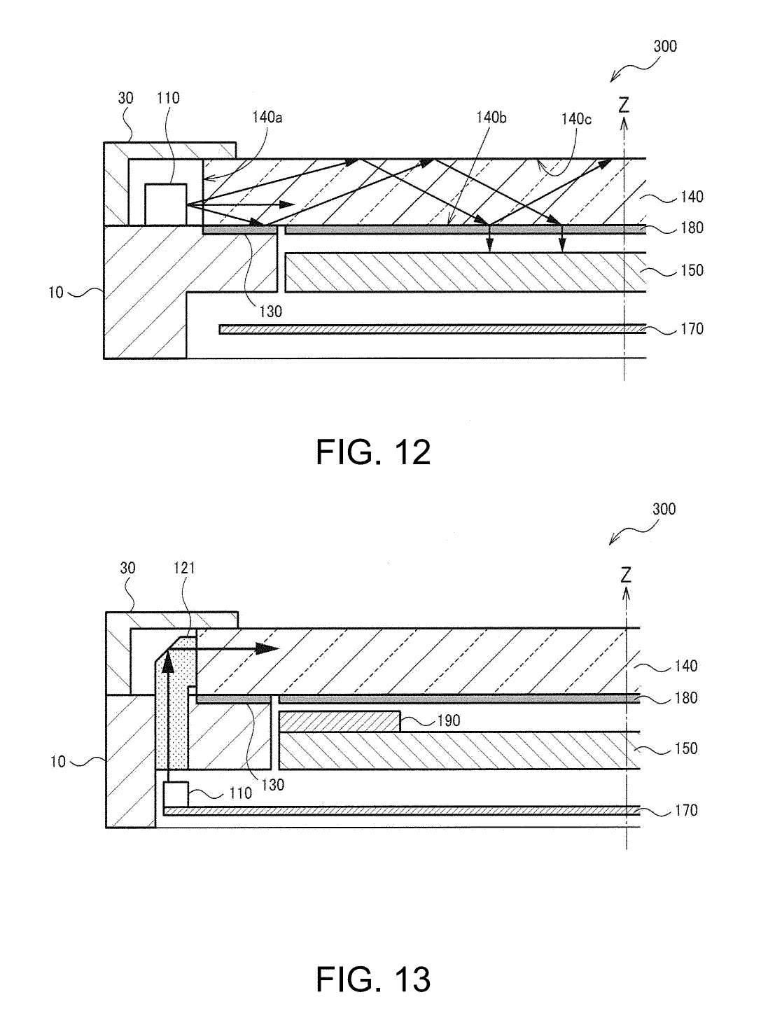

Note that, considering that light reflected on the display surface of the display panel 150 is increased, light emitted from the light emitting section 110 not only needs to be guided while being scattered and reflected in the cover 140 but also needs to be emitted from the lower surface 140b (a surface on the display panel 150 side) of the cover 140 and irradiated on the display surface of the display panel 150. Therefore, a modified implementation is possible in which, for example, the roughening is applied to not only the side surface 140a but also the lower surface 140b of the cover 140 or a member such as a sheet, the surface of which is an uneven shape, or a light scattering sheet is attached to the lower surface 140b of the cover 140. The modified implementation is explained below with reference to FIG. 12.

### 2. Second Embodiment

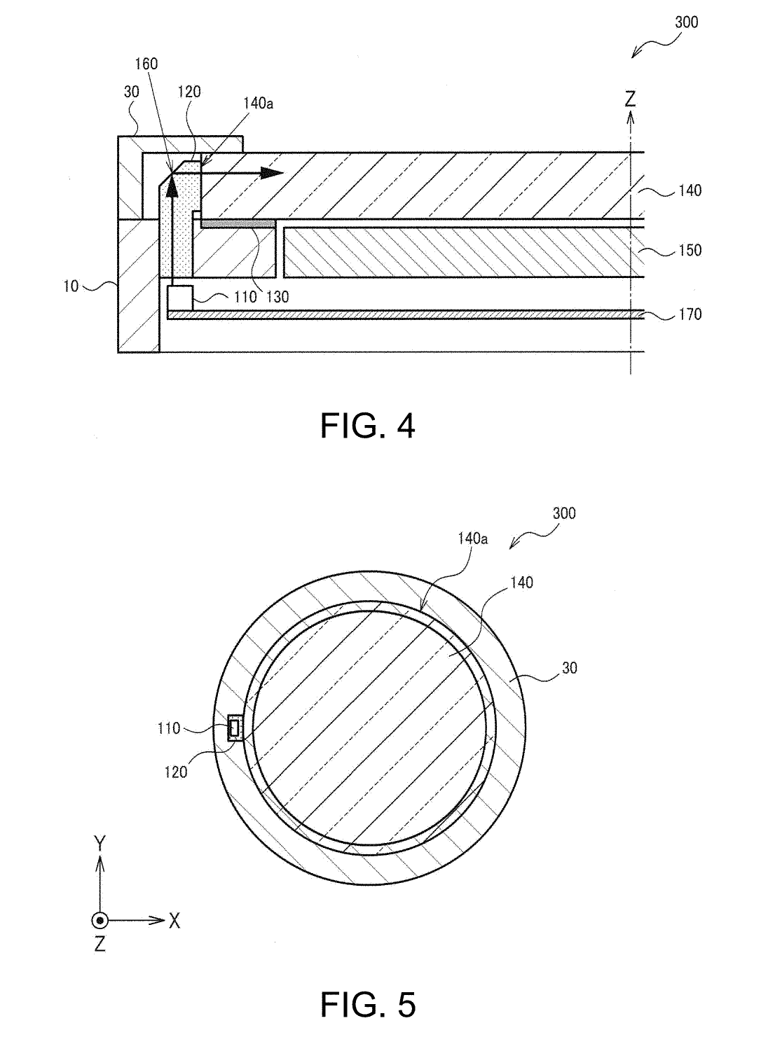

FIG. 4 is a sectional view of the display device 300 according to a second embodiment. FIG. 5 is a plan view corresponding to FIG. 4. As shown in FIG. 4, in the display device 300 according to this embodiment, the light emitting section 110 is provided on the inside of a housing section of the housing 10. With such a configuration, the light emitting section 110, a wire for electrically connecting the light emitting section 110 and the substrate 170, and the like can be disposed in the housing section, which is a closed space formed by the housing 10 and the cover 140. Therefore, in addition to a reduction in the thickness of the display device 300, it is possible to increase waterproof performance of the light emitting section 110 and reduce the size in the width direction of the display device 300 in the planar view from the Z-axis direction. Alternatively, it is possible to set a ratio of the display panel 150 in the display device 300 (a ratio of the size in the width direction in the planar view) larger than the ratio in the first embodiment.

As shown in FIG. 4, the light emitting section 110 is provided, for example, on the substrate 170 and at the circumferential edge portion of the cover 140 in the planar view. The substrate on which the light emitting section 110 is provided is the same substrate as the substrate 170 on which a processing circuit (a DSP (digital signal processor)) is provided. However, the light emitting section 110 may be provided on a different substrate.

In this embodiment, the cover 140 is disposed further on a +(positive) direction side of the Z axis than the light emitting section 110. As explained above in the first embodiment, to appropriately irradiate the display panel 150, it is desirable that light emitted from the light emitting section 110 is guided in a direction crossing the Z axis (guided along an XY plane) in the cover 140 while reflecting on an upper surface 140c and the lower surface 140b of the cover 140. However, in the disposition in this embodiment, because the positions in the Z-axis direction of the light emitting section 110 and the cover 140 are different, it is necessary to guide the light emitted from the light emitting section 110 in the +(positive) direction of Z axis, align the height of the light with the height of the cover 140, and change the direction of an optical path (an optical axis) to a direction crossing the Z-axis direction from the height.

Therefore, when a direction along a direction from the light emitting section 110 toward the cover 140 is represented as a first direction, the display device 300 according to this embodiment includes, as shown in FIGS. 4 and 5, a light guide body 120 that guides the light emitted from the light emitting section 110 in the first direction. The first direction is the +(positive) direction of the Z axis. The first direction may be considered a direction along (in a narrow sense, a direction parallel to) a direction from the display panel 150 toward the cover 140, may be considered a direction crossing (orthogonal to) the display panel 150, or may be considered a direction from the light emitting section 110 toward the bezel 30. The light emitted from the light emitting section 110 is made incident on the cover 140 via the light guide body 120. Note that, in other words, the first direction is a direction crossing (in a narrow sense, orthogonal to) the display surface of the display panel 150. A position where the light guide body 120 is disposed is a position (the outer side of the cover 140) surrounding the outer edge of the cover 140 in the planar view. The light guide body 120 is provided in a position overlapping the light emitting section 110 (FIG. 5). By providing the light guide body 120, even when the positions of the light emitting section 110 and the cover 140 in the first direction (the Z-axis direction) are different, it is possible to cause the cover 140 to more appropriately guide the light emitted from the light emitting section 110. In particular, even when the housing 10 not having light transmittance (not transparent) is located on the first direction side of the light emitting section 110, the light emitted from the light emitting section 110 is guided to the cover 140 by the light guide body 120 without being blocked by the housing 10.

The display device 300 may include the housing 10 to which the display panel 150 and the cover 140 are attached. The housing 10 and the light guide body 120 may be integrally formed. For example, a nontransparent first member (the housing 10) and a transparent second member (the light guide body 120) are integrally molded (two-color molded). As shown in FIG. 4, it is assumed that the light guide body 120 is provided to pierce through a part of the housing 10 in the Z-axis direction. In that regard, if the housing 10 and the light guide body 120 are integrally molded, the display device 300 (the housing 10) including the light guide body 120 can be easily formed. It is possible to increase waterproof performance of the display device 300 compared with when the housing 10 and the light guide body 120 are separately molded.

When a direction along the direction from the light emitting section 110 toward the cover 140 (the bezel 30) is represented as a first direction, the display device 300 includes a reflection surface 160 that reflects the light emitted from the light emitting section 110 in a second direction crossing the first direction. The first direction is the +(positive) direction of the Z axis and the second direction is a direction along the XY plane. Note that, in a narrow sense, the second direction is a direction from the circumferential edge portion toward the center of the cover 140 in the planar view among directions along the XY plane. The reflection surface 160 is a surface crossing each of the first direction (the Z axis) and the second direction (the direction along the XY plane) and is a surface on which a first angle, which is an angle formed by the reflection surface 160 and the first direction, and a second angle, which is an angle formed by the reflection surface 160 and the second direction, are substantially the same (in a narrow sense, the first angle=the second angle).

With such a configuration, the light guided in the first direction (the Z-axis direction) by the light guide body 120 can be guided in a direction along the surface of the cover 140. That is, even when the light emitting section 110 is provided in the housing 10, it is possible to appropriately irradiate the display panel 150 using the light emitted from the light emitting section 110. The light emitted from the light emitting section 110 is guided in the first direction via the light guide body 120 and reflected (guided) in the second direction by the reflection surface 160.

As a specific configuration of the reflection surface 160, various configurations are conceivable. For example, as shown in FIG. 4, the reflection surface 160 is formed on the light guide body 120. With such a configuration, it is possible to realize, with one member, the guiding of the light emitted from the light emitting section 110 in the first direction and the reflection of the light in the second direction.

FIG. 6 is another sectional view of the display device 300 according to this embodiment. FIG. 7 is a plan view corresponding to FIG. 6. As shown in FIGS. 6 and 7, the reflection surface 160 is formed at an end portion of the cover 140. The end portion represents the circumferential edge portion of the cover 140 in the planar view. In this case, the light emitted from the light emitting section 110 is guided in the first direction by the light guide body 120, made incident on the cover 140 from the lower surface 140b side, and reflected in the second direction on the reflection surface 160. With such a configuration, the reflection surface 160 only has to be formed at the end portion of the cover 140. Therefore, it is possible to simplify the shape of the light guide body 120. For example, as shown in FIG. 6, the light guide body 120 is a columnar member that pierces though the housing 10 in the Z-axis direction.

Note that, in the configuration shown in FIGS. 6 and 7, the light guide body 120 is covered by the cover 140 and is not exposed to the outside. Therefore, it is unnecessary to separately provide a member (e.g., the bezel 30 shown in FIG. 4) that covers the light guide body 120. However, in the embodiment shown in FIGS. 6 and 7, the bezel 30 can be further added. To increase reflection efficiency on the reflection surface 160 of the cover 140, processing for the reflection surface 160 may be performed. For example, vapor deposition of metal (e.g., aluminum) or the like may be performed on the reflection surface 160 of the cover 140 to mirror-finish the reflection surface 160.

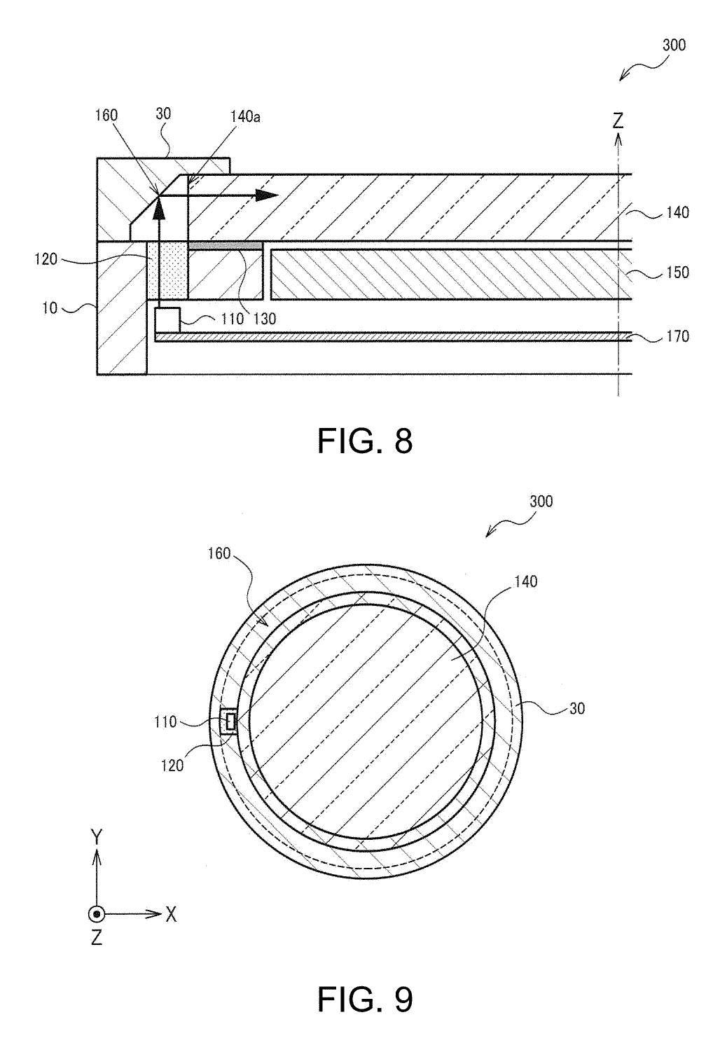

FIG. 8 is another sectional view of the display device 300 according to this embodiment. FIG. 9 is a plan view corresponding to FIG. 8. As shown in FIGS. 8 and 9, the display device 300 includes the bezel 30 provided in a position surrounding the cover 140 in the planar view for observing the display panel 150. The reflection surface 160 may be formed on the bezel 30. The bezel 30 is an edge-like member surrounding the outer circumference of the cover 140. More specifically, the bezel 30 is a member provided in a position equivalent to the outer circumference in the planar view of the housing 10. Note that the bezel 30 is not limited to the rotary bezel and may be a fixed bezel. In FIGS. 8 and 9, an example is shown in which a part of the bezel 30 and a part of the cover 140 overlap in the planar view. However, disposition of the bezel 30 and the cover 140 is not limited to this. For example, the inner circumferential end of the bezel 30 may be disposed to be further on the outer side than the outer circumferential end of the cover 140, that is, the bezel 30 and the cover 140 may be disposed not to overlap in the planar view.

Because the bezel 30 is made of metal, the bezel 30 is suitable for reflection of light. Therefore, by forming the reflection surface 160 on the bezel 30, it is possible to efficiently reflect the light emitted from the light emitting section 110 in the second direction. Note that, in FIG. 8, a space is provided between the light guide body 120 and the bezel 30. However, a modified implementation is also possible in which, for example, the shape of the light guide body 120 is changed to fill the space with the light guide body 120. Note that the bezel 30 is made of metal. However, the bezel 30 is not limited to this. A configuration may be adopted in which the bezel 30 is made of resin and metal is formed on the surface of the bezel 30 by vapor deposition.

Note that the three methods are explained above as the configuration of the reflection surface 160. However, in all the methods, the light emitted from the light emitting section 110 is made incident from a part of the cover 140. The light is propagated in the cover 140 from a region of the part by irregular reflection (scattering). Therefore, to cause the cover 140 to sufficiently brightly shine, it is necessary to prevent light from leaking from the side surface 140a of the cover 140. That is, as in the first embodiment, it is desirable to perform processing (shot blast) on the side surface 140a of the cover 140.

### 3. Third Embodiment

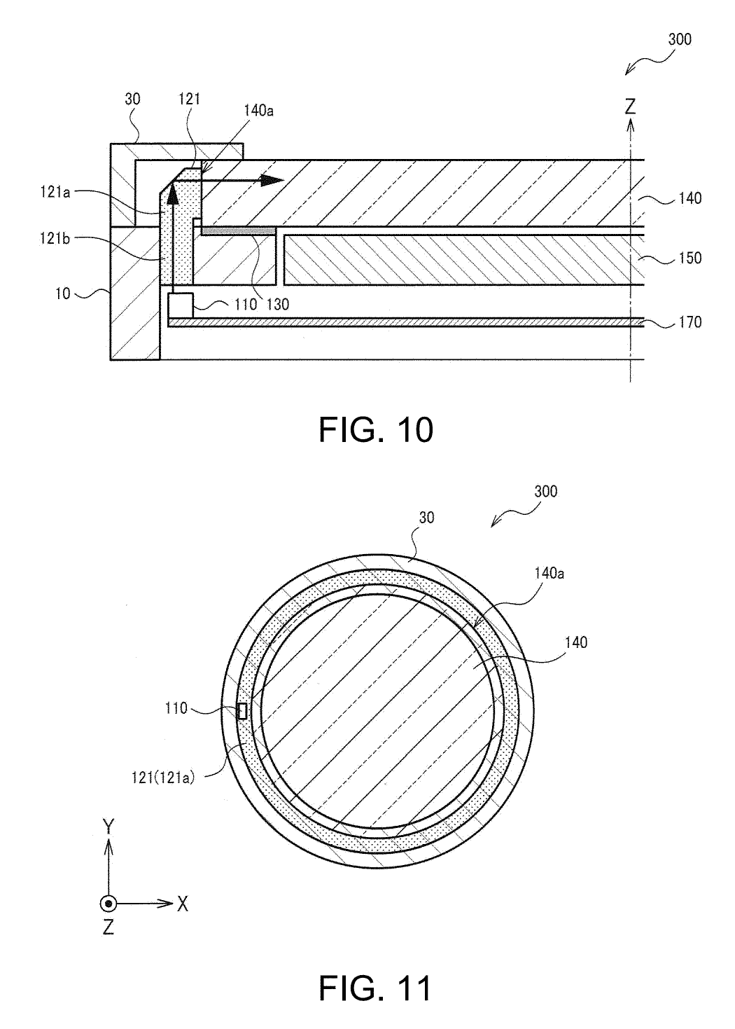

FIG. 10 is a sectional view of the display device 300 according to a third embodiment. FIG. 11 is a plan view corresponding to FIG. 10. As shown in FIG. 11, the display device 300 includes a ring-like light guide body 121 provided in a position surrounding the cover 140 in the planar view for observing the display panel 150. In this case, light emitted from the light emitting section 110 is guided by the ring-like light guide body 121 and made incident on the cover 140 from the surface of the ring-like light guide body 121 on the cover 140 side.

For example, the ring-like light guide body 121 includes a first member 121a having a ring shape, which is a shape surrounded by two circles (in a narrow sense, concentric circles), in the planar view. A circle representing the inner circumference of the first member 121a is the same as a circle representing the outer circumference of the cover 140 or a circle larger than the outer circumference of the cover 140 (coinciding with or including the circle representing the outer circumference of the cover 140). However, the circle is not limited to a perfect circle and includes a substantially circular shape.

The ring-like light guide body 121 includes a second member 121b that guides the light emitted from the light emitting section 110 in the first direction toward the bezel 30. The second member 121b is a member provided in a position overlapping the light emitting section 110 in the planar view. The second member 121b is realized by the same shape as the light guide body 120 shown in FIG. 6. The light emitted from the light emitting section 110 is guided in the first direction by the second member 121b and guided to the ring-like first member 121a from the second member 121b. It is assumed that the first member 121a and the second member 121b are integrally formed. However, the first member 121a and the second member 121b may be separately formed.

In the first and second embodiments, the light emitted from the one light emitting section 110 is made incident on one part of the cover 140. Therefore, to reduce light emission unevenness of the cover 140, it is necessary to increase light dispersion (scattering) of the cover 140 or provide the plurality of light emitting sections 110. On the other hand, in the method in this embodiment, the outer edge of the cover 140 is surrounded by the ring-like light guide body 121. Therefore, it is possible to make lights incident on the cover 140 from a large number of directions (in a narrow sense, the entire circumference). It is possible to reduce the light emission unevenness of the cover 140, that is, irradiate the display surface of the display panel 150 without unevenness. In the first and second embodiments, the example is explained in which the processing for preventing light from leaking is performed on the side surface 140a of the cover 140. However, in this embodiment, because the side surface 140a is covered by the ring-like light guide body 121, it is possible to omit the processing such as the shot blast.

Note that, in this embodiment, even if only a small number of (in a narrow sense, one) light emitting sections 110 are provided, it is possible to reduce the light emission unevenness of the cover 140. However, the plurality of light emitting sections 110 may be provided to, for example, increase the intensity of light.

The display device 300 includes the housing 10 to which the display panel 150 and the cover 140 are attached. The housing 10 and the ring-like light guide body 121 are integrally formed. By integrally molding (two-color molding) the housing 10 and the ring-like light guide body 121, as in the second embodiment, it is possible to increase waterproof performance of the display device 300.

### 4. Modifications

Several modifications are explained below. Note that the modifications explained below may be combined with any one of the first to third embodiments.

FIG. 12 is a sectional view of the display device 300 according to a first modification. By processing the side surface 140a of the cover 140 or surrounding the side surface 140a of the cover 140 with the ring-like light guide body 121, it is possible to irregularly reflect (scatter) light emitted from the light emitting section 110 in the cover 140 and shine the cover 140. However, the cover 140 is used as a frontlight. It is more important for the cover 140 to irradiate the light on the display surface of the display panel 150 than shining itself.

Therefore, on the surface (the lower surface 140b) of the cover 140 on the display panel 150 side, it is desirable that grooves of a predetermined pattern are formed. For example, the grooves may be fine lattice-like grooves, may be brazed lattice-like groove, or may be sine wave-like grooves or curved surface-like grooves. In any case, the grooves provided on the lower surface 140b have action of emitting a part of light reflected in the cover 140 to the outside, that is, in the direction of the display surface of the display panel 150 from the lower surface 140b. With such a configuration, it is possible to increase visibility of the display panel 150.

Note that the grooves provided on the cover 140 may be formed by applying processing to the cover 140 itself. Alternatively, as shown in FIG. 12, a sheet on which grooves of a given pattern are formed (a light scattering sheet 180, etc.) may be bonded to the lower surface 140b of the cover 140.

FIG. 13 is a sectional view of the display device 300 according to a second modification. As shown in FIG. 13, the display device 300 may include a solar panel 190. In the example shown in FIG. 13, the solar panel 190 is provided between the cover 140 (the light scattering sheet 180) and the display panel 150 and in a region overlapping the circumferential edge portion of the display panel 150 in the planar view. In the wearable device 200 and the like, because a limitation on a battery capacity is large, it is possible to, for example, extend an operation time by performing power generation by the solar panel 190.

When the solar panel 190 is provided as shown in FIG. 13, a product thickness of the display device 300 increases. In that regard, an affinity between the display device 300 including the solar panel 190 and the method in this embodiment for enabling a reduction in thickness is high. Alternatively, the solar panel 190 and the light scattering sheet 180 may be disposed not to overlap in the Z-axis direction (to be arranged in the direction along the XY plane). In this case, the product thickness is not a sum of the thicknesses of the solar panel 190 and the light scattering sheet 180 and is determined by a larger one of the thicknesses of the solar panel 190 and the light scattering sheet 180. Therefore, it is possible to realize a thin display device 300 with an efficient configuration.

Note that the display device 300 explained above may be a display unit in which a component configuring a part of a completed product, that is, the cover 140 is used as a light guide body. In that case, various instruments (devices and terminals) can be mounted on the display device 300. For example, the method in this embodiment may be applied to an electronic device 100 (e.g., a portable terminal device) including the display device 300 or, as explained above, may be applied to the wearable device 200 including the display device 300.

The embodiments and the modifications applied with the invention are explained above. However, the invention is not limited to the embodiments and the modifications per se. At an implementation stage, the constituent elements can be modified and embodied within a range not departing from the spirit of the invention. Various inventions can be formed by combining, as appropriate, a plurality of constituent elements disclosed in the embodiments and the modifications. For example, several constituent elements may be deleted from all the constituent elements described in the embodiments and the modifications. Further, the constituent elements explained in the different embodiments and modifications may be combined as appropriate. Terms described together with broader-sense or synonymous different terms at least once in the specification or the drawings can be replaced with the different terms in any place of the specifications or the drawings. In this way, various modifications and applications are possible in a range not departing from the spirit of the invention.

What is claimed is:

1. A display device comprising:
a display panel;
a light emitting section; and
a cover provided on a side of a display surface of the display panel and configured to guide light emitted from the light emitting section and irradiate the display surface.

2. The display device according to claim 1, further comprising a ring-like light guide body provided to surround the cover in a planar view from a direction crossing the display surface.

3. The display device according to claim 2, further comprising a housing to which the display panel and the cover are attached, wherein
the housing and the ring-like light guide body are integrally formed.

4. The display device according to claim 1, further comprising a reflection surface configured to, when a direction from the light emitting section toward the cover is represented as a first direction, reflect the emitted light in a second direction crossing the first direction.

5. The display device according to claim 4, further comprising a light guide body configured to guide the emitted light in the first direction.

6. The display device according to claim 5, further comprising a housing to which the display panel and the cover are attached, wherein
the housing and the light guide body are integrally formed.

7. The display device according to claim 5, wherein the reflection surface is formed on the light guide body.

8. The display device according to claim 4, wherein the reflection surface is formed at an end portion of the cover.

9. The display device according to claim 4, further comprising a bezel provided to surround the cover in a planar view from a direction crossing the display surface, wherein
the reflection surface is formed on the bezel.

10. The display device according to claim 1, wherein grooves of a predetermined pattern are formed on a surface of the cover on a side of the display panel.

11. The display device according to claim 1, wherein the display panel is either a reflection-type liquid crystal panel or an electrophoresis display device.

12. An electronic device comprising the display device according to claim 1.

13. An electronic device comprising the display device according to claim 2.

14. An electronic device comprising the display device according to claim 3.

15. An electronic device comprising the display device according to claim 4.

16. An electronic device comprising the display device according to claim 5.

17. A wearable device comprising the display device according to claim 1.

18. A wearable device comprising the display device according to claim 2.

19. A wearable device comprising the display device according to claim 3.

20. A wearable device comprising the display device according to claim 4.
